(19) United States
(12) Patent Application Publication
(10) Pub. No.: US 2013/0229578 A1
(43) Pub. Date: Sep. 5, 2013

(54) On-screen Additions to Movie Presentations

(71) Applicant: Russell Benton Myers, Grants Pass, OR (US)

(72) Inventor: Russell Benton Myers, Grants Pass, OR (US)

(21) Appl. No.: 13/412,348

(22) Filed: Mar. 5, 2012

(51) Int. Cl. H04N 5/445

(52) U.S. Cl. 348/563; 348/E05.099

(57) ABSTRACT

In accordance with one or more aspects, on-screen addition is displayed over a feature or short film presentation. The on-screen addition may consist of advertising, logos, or identification material to identify the source of the film being presented. The on-screen addition is displayed in such a manner as to be visible to a person viewing the film presentation. Still images, moving images, or any combination of still and moving images may constitute the displayed on-screen addition.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

The present invention relates to information that is displayed during a movie and, more specifically, to separate images shown with movie media that are displayed in addition to the movie for purposes of identification, information or advertising.

2. Description of the Related Art

Digital on-screen graphics or digitally-originated graphics (DOGs), known in the U.S. and Canada as bugs, first appeared in the early 1980s on VH1 and MTV television channels. They were first used as channel identification for television. Now, almost all TV channels use DOGs in the form of graphics that overlay a televised image. Advertising station logos, upcoming shows, and occasionally information like the time or date, or weather are displayed as DOGs. Another purpose of DOGs is to deter copyright infringement. Copyright infringement of audio-visual works, often referred to as piracy, occurs when unauthorized copies are made of music, movies and similar works. Illegal copies of TV shows are easily identified and traced through DOGs. DOGs helped reduce the piracy of TV shows by propagating source identifiers through all recordings of the show.

Until recently, encrypting digital video disks (DVDs) successfully reduced the unauthorized copying of movies. Today, the internet and modern technology has made movie piracy a growing problem. Additional means for piracy prevention, other than the current computer-based DVD encryption methods, are being sought by Hollywood production companies. Hollywood is also looking for new ways to allow advertisers to display their goods and services to movie patrons. The demand for improved copyright protection methods and the need for new advertising techniques in movies necessitates the use of DOG type technology.

The movie industry is suffering tremendous effects from piracy. Total box office gross income was $10.5 billion in 2010 compared to $8.9 billion in 2005, but losses from movie piracy range from 1.3 to 6.1 billion depending on the source. The exact impact of piracy in the film industry to the economy is hotly debated but all agree it costs the movie industry over a billion dollars a year. In addition, piracy is estimated to cost U.S. film industry workers 100,000 jobs a year. The present invention provides a new system and method to help decrease movie piracy by providing visual deterrents for tracking and identifying the original source of theatrical content. A small identifier such as a logo, brand name, or other identification information could be overlaid onto a movie image during presentation.

The movie industry presently makes very little of its money from advertising; almost all of the industry's revenue is generated from ticket sales. The present invention provides a new method for increasing the movie industry's gross income by increasing its advertising revenue through the use of one or more small advertisements that may be overlaid onto a movie image during presentation. The advertising overlays may also act as a piracy deterrent because producers could identify the displayed advertisement or sequence of advertisements in an illegally pirated version of the movie. The advertising overlays would help increase revenue and reduce piracy without changing the original movie content.

An additional benefit of DOGs and other types of image overlays, including the present invention, is that they do not extend the length of the presentation because DOGs they may be shown concurrently with the underlying content. With feature films frequently exceeding two hour play times, displaying product advertising, information, or other branding to movie patrons without requiring them to sit through additional screens of information helps keep feature film showtimes as short as possible.

### BRIEF SUMMARY OF THE INVENTION

Embodiments are disclosed to provide graphical on-screen additions to movie presentations. The on-screen additions can be used to indicate the source of the movie presentation, or to display information or advertisements to the movie viewer.

In a preferred embodiment of the present invention, the on-screen addition is a semi-transparent production company logo that overlays a small region of the movie image. This preferred embodiment may serve as a piracy deterrent because it may propagate through illegally copied versions of the movie. The exact position, size, shape, coloring and other visual characteristics of this preferred on-screen addition embodiment may remain constant throughout the display of the addition, or may change as time progresses.

In another preferred embodiment of the present invention, the on-screen addition is an animated advertisement showing a popular brand-name product overlaid across some or all of the movie image. The visual characteristics of the advertisement in this preferred embodiment may remain constant throughout the display of the advertisement, or may change as time progresses.

In yet another preferred embodiment of the present invention, the on-screen addition is a combination of moving and still images that are displayed over some or all of the movie image. According to this preferred embodiment, the stars of a popular television program may be shown moving around the screen while the name of the television program is displayed in a static location immediately below or elsewhere on the movie screen.

### BRIEF DESCRIPTION OF THE SEVERAL VIEWS OF THE DRAWING(S)

FIG. 1 is a block diagram of an exemplary method for displaying on-screen additions to movie presentations as according to one embodiment of the present invention;

FIG. 2 is a view of a movie screen showing exemplary quadrant locations where on-screen additions may be shown as according to one embodiment of the present invention;

FIG. 3 is a view of a movie screen showing exemplary top and bottom locations where on-screen additions may be shown as according to one embodiment of the present invention;

FIG. 4 is a view of a movie screen showing exemplary side locations where on-screen additions may be shown as according to one embodiment of the present invention;

FIG. 5 is a view of a movie screen showing an exemplary central location where on-screen additions may be shown as according to one embodiment of the present invention;

A further understanding of the present invention can be obtained by reference to a preferred embodiment set forth in the illustrations of the accompanying drawings. Although the illustrated embodiment is merely exemplary of methods for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

In a manner described below, the data processing aspects of the present invention may be implemented, in part, by programs that are executed by a computer. The term “computer” as used herein includes any device that electronically executes one or more programs, such as personal computers (PCs), hand-held devices, multi-processor systems, microprocessor-based programmable consumer electronics, network PCs, minicomputers, mainframe computers, routers, gateways, hubs and the like. The term “program” as used herein includes applications, routines, objects, components, data structures and the like that perform particular tasks or implement particular abstract data types. The term “program” as used herein further may connote a single program application or module or multiple applications or program modules acting in concert. The data processing aspects of the invention also may be employed in distributed computing environments, where tasks are performed by remote processing devices that are linked through a communications network. In a distributed computing environment, programs may be located in both local and remote memory storage devices.

The terms “film” and “movie” may be used interchangeably herein to refer to both feature films that are made for initial distribution in theaters and are the main attraction of screening, or to short films that are screened before a feature film. Although the following description and claims may refer to a film in the singular, it is understood that “film” may refer to films in the multiple. Furthermore, the terms “on-screen addition(s)” and “addition(s)” may be used interchangeably herein to refer to the present invention.

Several preferred embodiments for displaying on-screen additions to movie presentations are discussed in this section. However, the invention is not limited to these embodiments. On-screen additions are often shown as any image displayed at the same time as a movie over the movie picture. They are not limited in method of display, image type, data type, position, size or accompaniment.

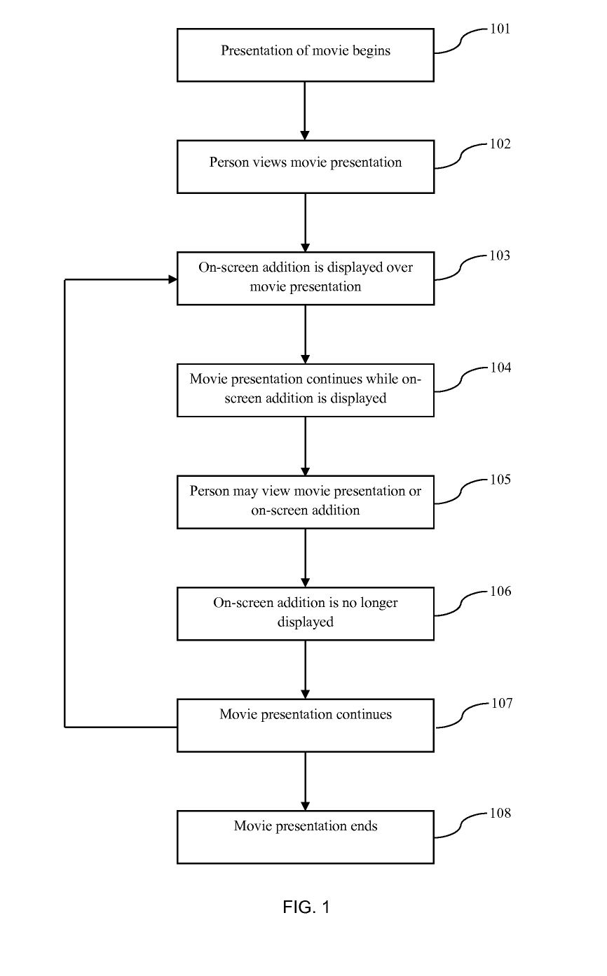

Referring now to FIG. 1, there is shown an exemplary method for displaying on-screen additions to movie presentations as according to one embodiment of the present invention. A movie presentation begins (101) when a movie is shown to a person viewing the movie presentation (102). The movie presentation may occur within a theater, in a home, in a vehicle, on a computer, or any other location where movies may be viewed. During the movie presentation, an on-screen addition is displayed over some or all of the movie presentation (103). The movie presentation continues while the on-screen addition is displayed (104). While the on-screen addition is displayed, a movie viewer may focus her attention on the on-screen addition, the movie, or may alternate focus between the two (105). After an amount of time has elapsed, the on-screen addition is no longer displayed (106) and the movie presentation continues (107). Multiple on-screen additions may be shown during the movie presentation and if subsequent on-screen additions are displayed, the steps of 103-107 may be repeated. Regrettably, all movie presentations must eventually end (108) and the illustrated method finishes.

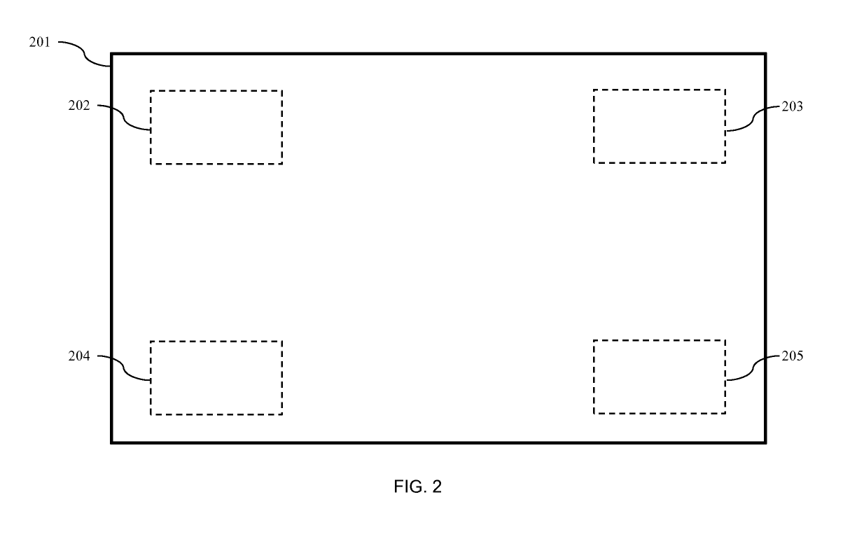

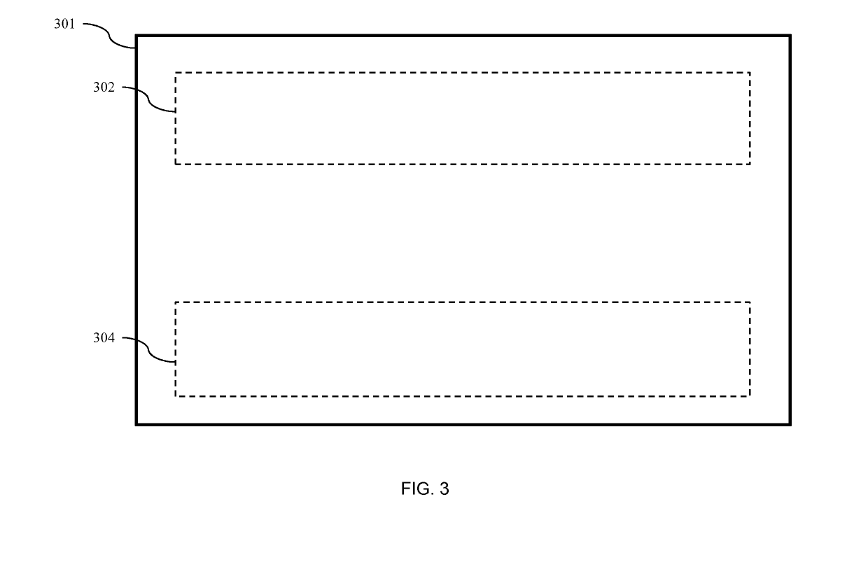

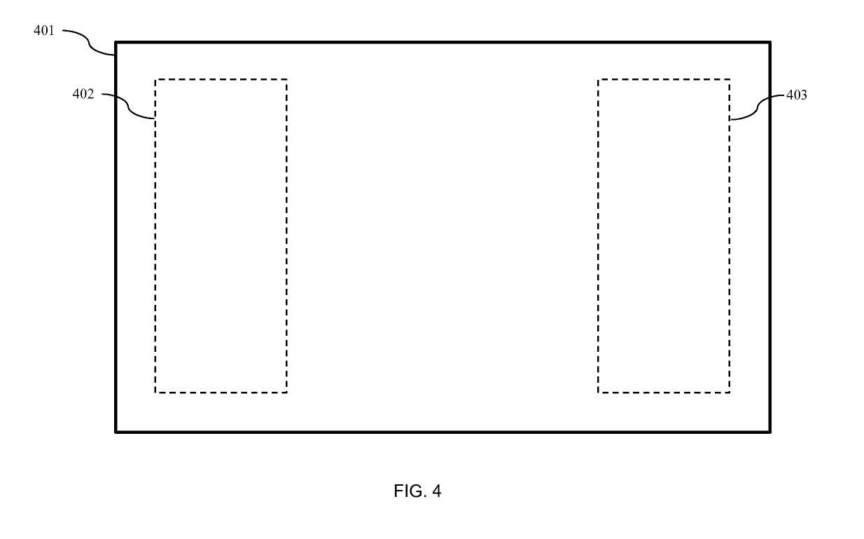

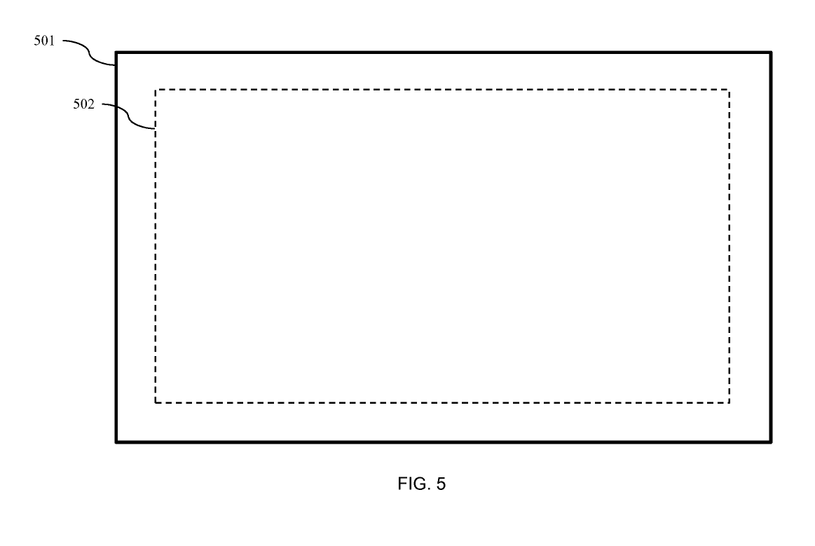

Referring now to FIGS. 2-5, there are shown exemplary locations for displaying on-screen additions to movie presentations as according to one or more embodiments of the present invention. A movie screen (201, 301, 401, 501) is shown with possible locations for displaying on-screen additions during a movie presentation. On-screen additions may be shown in one or more corners of the screen (202, 203, 204, 205) during a movie presentation. The exact size, shape, and duration of the addition is variable and may be any size, shape, and duration as deemed appropriate for the addition being displayed. On-screen additions may be shown along the top (302) of a movie screen (201, 301, 401, 501), along the bottom (304) of the movie screen (201, 301, 401, 501), or simultaneously along both the top (302) and bottom (304) of a movie screen (201, 301, 401, 501). It also possible to display on-screen additions on either side (402, 403) of a movie screen (201, 301, 401, 501). An on-screen addition may even begin at the left side (402) and transition to the right side (403) of a movie screen (201, 301, 401, 501) while the addition is being displayed to the movie viewer. An on-screen addition may even be displayed on both sides (402, 403) of the movie screen (201, 301, 401, 501) simultaneously. An on-screen addition may also be shown over all or most (502) of the movie screen (201, 301, 401, 501) while the movie is being presented. An onscreen addition could start in any portion of a movie screen (201, 301, 401, 501), but move across most or all (502) of the movie screen (201, 301, 401, 501) while it is being displayed.

The exemplary locations for the on-screen addition shown in FIGS. 2-5 may be combined in any exemplary embodiment of the present invention. By way of example, an on-screen addition could begin in the lower-left quadrant (204) of a movie screen (201, 301, 401, 501) then be shown in the top portion 302 of the movie screen (201, 301, 401, 501) later in its period of display. An on-screen addition could also be shown in both the bottom portion (304), right side (403), and in the top-left quadrant (202) of the movie screen (201, 301, 401, 501) during the addition's display period. Multiple copies of the on-screen addition could be shown in any combination of locations shown in FIGS. 2-5.

In any embodiment of the present invention, the on-screen addition could be of sufficient transparency to allow the underlying movie to show through, or may be of an opaque nature as to partially or completely block the movie presentation. The on-screen addition could be graphical in nature only, or could be accompanied by sounds, music, or noises.

In one exemplary embodiment of the present invention on-screen additions are displayed in a movie theater by a device that plays the on-screen additions image at the same time as the movie. In this preferred embodiment, the on-screen addition image is displayed over the movie image during part or all of the movie presentation. The on-screen addition image may be partially translucent, opaque, or solid and completely obscuring the underlying movie presentation. The on-screen addition image could be played by the theater managers at any time, in any position, using any image or over any movie. The on-screen addition images may be still images or a moving video images. In an exemplary embodiment of the present invention, the on-screen addition image is a movie production company logo. In another exemplary embodiment of the present invention, the on-screen addition image is the time and date with an accompanying brand name soda bottle that is open with bubbles emanating from the bottle. The on-screen addition could have been any image, but in this embodiment the image provides a watermark that can be used to prevent piracy, an advertisement that may boost sales of soda in the theater and the soda company may have paid for that time slot as well. This embodiment of an on-screen addition may prevent piracy as a visual deterrent and be used to catch perpetrators. Often movies are illegally copied by movie viewers who bring in recording devices and copy the film straight from the screen. In this embodiment, if someone had tried to copy the movie with a hand held camera the on-screen addition would be on the copy. Since valid movies wouldn't have on-screen additions the copy is now marked as a pirated copy, which is less desirable or sale. Also the cinema logo, time stamp, and advertisement appearing on pirated copies may help investigators track down the original perpetrator.

In another exemplary embodiment of the present invention the on-screen additions is shown embedded in a movie played on a website. In this embodiment the movie programing code has been changed to incorporate an on-screen addition. In this example this on-screen addition image would be permanently entwined with this movie file. In this embodiment the on-screen addition shows a website logo with the time the download occurred, the internet Protocol (IP) address of the recipient, and an advertisement consisting of an image of a truck with its company logo and a sound of a big engine. This example plays this on-screen addition as a small image in the right bottom of the movie window during the movie, over-laid on the movie image, 20 minutes into the film. In this example, the on-screen additions is programed into the film data and is set for each viewing of the movie on the website; only the individual data (IP address and time) would change but not the programing data in the film data. Every time the movie is downloaded from this site this version of the on-screen addition would appear the same except for the individual data. This embodiment helps prevent and track piracy while providing advertising revenue to the movie company to help pay for downloadable movies. The data in this embodiment of the on-screen addition would insure that all copies of the movie could be instantly recognized as ligament or not. Also, this embodiment could be easily used to track down the source of illegal movie downloads.

In yet another exemplary embodiment of the present invention, would be to use on-screen additions on movie DVDs for both copyright protection, and advertising. In this embodiment the on-screen addition data file is imbedded into the movie data file on a tangible media source like a DVD. The image could be a recognizable cartoon figure promoting its upcoming movie release; this would function as both an advertisement and a watermark.

In yet another exemplary embodiment of the present invention, the on-screen addition is placed on the original film file shortly before distribution but after the movie it completed. This may help identify illegal copies of the movie that are released early. If the on-screen addition is changed periodically or for different regions or different distributors, then illegal copies could be traced more accurately.

In yet another exemplary embodiment of the present invention the on-screen addition is chosen for a certain demographic based on multiple factors including but not limited to the demographic of the movie, the demographic of the audience at the time the movie is shown, a website's prime demographic, a cinema's location, or even the weather at the time of showing. An advertisement of an ice cream float may be more effective on an on-screen addition shown in California to families in the month of August than one shown in Alaska in January during an adult film. An on-screen addition of a beer advertisement may be more effective in the latter. On-screen additions that are shown in the movie theater from a separate device that overlays the on-screen additions image over the movie can be easily changed from day to day or movie to movie, and are well suited to adjusting to different demographics while still helping reduce piracy. It has been noted that certain movies, regions and movie times are more prone to illegal copping and this embodiment of the on-screen additions display system could choose to increase the amount of on-screen additions or change the on-screen addition type to help deter piracy further in prime films, areas and times.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of this disclosure are not limited to such devices, standards and/or protocols. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
displaying, during a movie presentation, an on-screen addition over the movie presentation so that the on-screen addition is visible to a person viewing the movie presentation; and
continuing the movie presentation as the on-screen addition is displayed.

2. The method of claim 1, wherein the on-screen addition is advertising.

3. The method of claim 1, wherein the on-screen addition is a logo.

4. The method of claim 1, wherein the on-screen addition identifies the source of the movie presentation.

5. The method of claim 1, wherein the on-screen addition is comprised of one or more still images.

6. The method of claim 1, wherein the on-screen addition is comprised of moving images.

7. The method of claim 1, wherein the on-screen addition is comprised of a combination of still images and moving images.

8. The method of claim 1, wherein the movie presentation is a feature film.

9. The method of claim 1, wherein the movie presentation is a short film.

10. A system for displaying information during a movie comprising:
a movie presentation;
an on-screen addition that is displayed over part or all of the movie presentation;
a means for displaying the on-screen addition.

11. The system of claim 10, wherein the on-screen addition is advertising.

12. The system of claim 10, wherein the on-screen addition is a logo.

13. The system of claim 10, wherein the on-screen addition identifies the source of the movie presentation.

14. The system of claim 10, wherein the on-screen addition is comprised of one or more still images.

15. The system of claim 10, wherein the on-screen addition is comprised of moving images.

16. The system of claim 10, wherein the on-screen addition is comprised of a combination of still images and moving images.

17. The system of claim 10, wherein the movie presentation is a feature film.

18. The system of claim 10, wherein the movie presentation is a short film.

19. A device having storage media;
the storage media having stored thereon on-screen addition that, when accessed, is displayed over a movie presentation so that the on-screen addition is visible to a person viewing the movie presentation.

20. The device of claim 19, wherein the on-screen addition is advertising.

21. The device of claim 19, wherein the on-screen addition is a logo.

22. The device of claim 19, wherein the on-screen addition identifies the source of the movie presentation.

23. The device of claim 19, wherein the on-screen addition is comprised of one or more still images.

24. The device of claim 19, wherein the on-screen addition is comprised of moving images.

25. The device of claim 19, wherein the on-screen addition is comprised of a combination of still images and moving images.

26. The device of claim 19, wherein the movie presentation is a feature film.

27. The device of claim 19, wherein the movie presentation is a short film.
